(19) United States
(12) Patent Application Publication
(10) Pub. No.: US 2024/0060469 A1
(43) Pub. Date: Feb. 22, 2024

(54) Wind Turbine with a Virtual Ammonia Battery

(71) Applicant: Jeremy J Papadopoulos, Manchester (GB)

(72) Inventor: Jeremy J Papadopoulos, Manchester (GB)

(73) Assignee: T-Omega Wind, Milton, MA (US)

(21) Appl. No.: 18/451,655

(22) Filed: Aug. 17, 2023

Related U.S. Application Data
(60) Provisional application No. 63/371,666, filed on Aug. 17, 2022.

(51) Int. Cl. F03D 9/19; F03D 13/25; H02K 7/18; C25B 1/27; C25B 5/00; C25B 9/65

(52) U.S. Cl. CPC F03D 9/19; F03D 13/25; H02K 7/183; C25B 1/27; C25B 5/00; C25B 9/65; F05B 2240/95

(57) ABSTRACT

A method and apparatus for storing energy in the form of liquid ammonia by converting mechanical energy from wind to liquid-fuel energy with an offshore wind-turbine apparatus is disclosed. Electrical energy generated by the turbine is used in an electrolysis process to convert sea water to liquid ammonia. The fuel may be stored in containers on a barge for electrical energy production through a fuel cell or for transfer to another vessel.

### TECHNICAL FIELD

The present disclosure relates in general to wind turbines and more specifically to offshore wind turbines that store energy as chemical fuels.

### BACKGROUND

A wind turbine is a rotating machine that converts kinetic energy from wind into mechanical energy that is converted to electricity. Utility-scale, horizontal-axis wind turbines have horizontal shafts that drive a generator assembly within a tower-top nacelle, that is yawed relative to the tower in order to align the rotor with the wind. Either a transmission and generator combination or a larger direct drive generator is commonly used.

The state of the art includes offshore wind turbines that rest on the ocean bottom and are neither built nor intended to be moved. In waters shallower than 60 m, wind turbines used for offshore applications commonly include single-tower systems mounted to the sea bed. In deeper waters the turbines must float, using spar-buoy or semi-submersible platforms, tension legs, or a large-area barge-type construction. Offshore turbines are usually connected to a local power grid and electrical energy produced is transferred by ocean-floor grid structures.

One skilled in the art understands that electrical energy from a wind driven shaft may be employed to convert various raw materials to liquid fuels by various processes. For example methanol, DME, hydrazine or other compounds with or without carbon may be harvested from an environment. The conversion of electrical energy to ammonia provides a carbon free liquid fuel. The meaning of carbon free is that carbon is not emitted in creating the fuel, and that any carbon emitted in using the fuel was previously taken from the atmosphere to create the fuel.

Ammonia has a raw energy density that is equal to about one third that of diesel oil. It can be burned as a fuel in a wide range of engines, turbines, furnaces, boilers etc. It can also be converted to hydrogen and used to power hydrogen fuel cells, or it may be used directly within high-temperature direct ammonia solid-oxide fuel cells to provide electricity. In all these applications green ammonia is a fuel that does not create greenhouse gases. It is far easier to store and transport than hydrogen.

One skilled in the art is familiar with various processes by which ammonia is produced. The primary reaction is:

N₂+3H₂−>2NH₃

Nitrogen and hydrogen may be derived from an ocean environment. Hydrogen may be separated from water in an electrolyzer, for example, and nitrogen may be separated from air.

Increased adoption of renewable electricity challenges utilities to balance supply and demand on an energy-distribution grid. When the wind blows harder than needed, generation must be curtailed because customers cannot use it. Conversely when the wind blows less than needed, customers cannot be served unless there is a stored energy option or a backup fuel-powered generating plant.

### SUMMARY

An apparatus for converting mechanical energy from wind to liquid-fuel energy is an offshore wind turbine with associated fuel synthesis hardware and is referred to as a virtual ammonia battery. Electrical energy generated by the turbine is used to convert water to fuel in a liquid form such as compressed ammonia. The ammonia may then be used as fuel to generate electricity when wind is not blowing sufficient to power the wind turbine or when additional power is required.

In an example embodiment, an apparatus has at its central portion a horizontal structure that is configured to support electrical-generation equipment driven by a wind-turbine rotor. This rotor center is supported on a plurality of legs, each with a shallow float at the base.

Electrical energy is used in an electrolysis process to convert sea water to ammonia. Liquid ammonia may be stored in tanks that may be located beneath the water surface, on the ocean floor, or on a nearby barge. In some embodiments, a liquid fuel is stored in containers on a barge to be used to create electrical energy when the wind is insufficient for the turbine to produce electrical energy. One skilled in the art understands that fluid fuel stored on a barge may also be transferred to a vessel or otherwise transported to land.

A wind turbine that produces a stored fuel such as ammonia can eliminate many problems associated with renewable energy. The fuel can be transported around the world, from locations of great wind resources to populations needing clean energy. The turbines can be installed in locations where permit requirements are minimal, such as remote or international waters. The fuel, when shipped to destination ports, can be used to generate electricity as needed. In particular it can provide adequate power independent of when the wind blows. Ammonia may be used directly as a fuel, or can power an ammonia fuel cell, or may be converted to hydrogen for many uses including a hydrogen fuel cell.

Other objects and features will become apparent from the following detailed description considered in conjunction with the accompanying drawings. It is to be understood, however, that the drawings are designed as an illustration and not as a definition of the limits of the invention.

### BRIEF DESCRIPTION OF THE DRAWINGS

FIG. 1 is a perspective view of an example embodiment of the present disclosure;

FIG. 2 is diagram thereof.

### DESCRIPTION

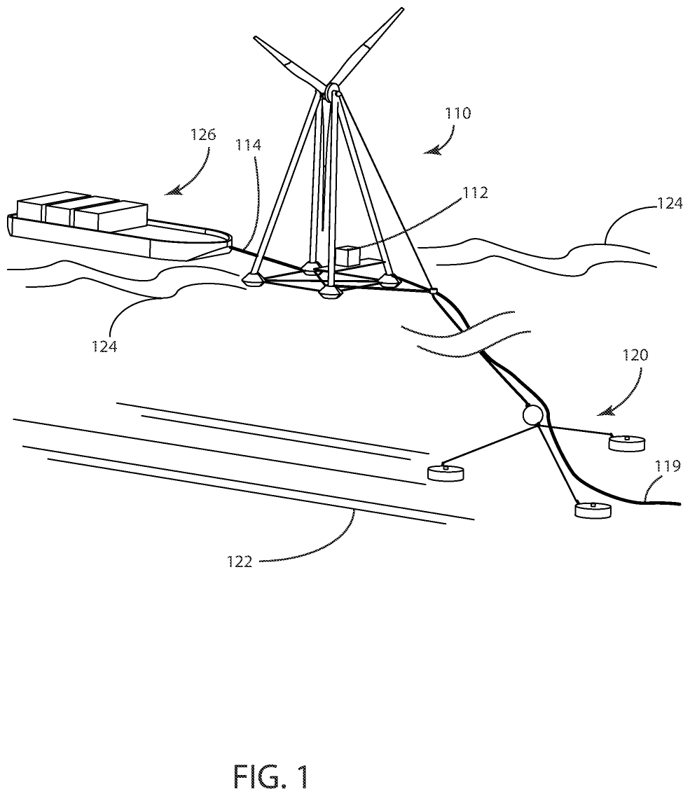

FIG. 1 is a perspective view of an example embodiment 100 with a moored wind turbine 110 floating on the ocean surface 124. The turbine is moored to the ocean floor 122 by a mooring apparatus 120. Electrical energy generated by the wind turbine is used to convert water to liquid fuel such as ammonia in an electrolyzer 112. Liquid fuel is transferred along conduit 114 to storage container on a nearby barge 126. At modest pressures ammonia remains in liquid form, so it can be stored in a water surface tank or barge 126. This fuel can be employed in various advantageous ways: The barge may transport it to land for use in power plants, vehicles, or industrial processes. Or it may be used in a fuel cell on the wind turbine structure, to generate electricity for distribution to a utility grid. Tanks on the barge may be switched out to fuel a boat or the barge may be taken ashore for distribution. One skilled in the art understands that liquid fuel stored in containers on a barge, may be used to power an electrolyzer to provide electrical energy to a power grid.

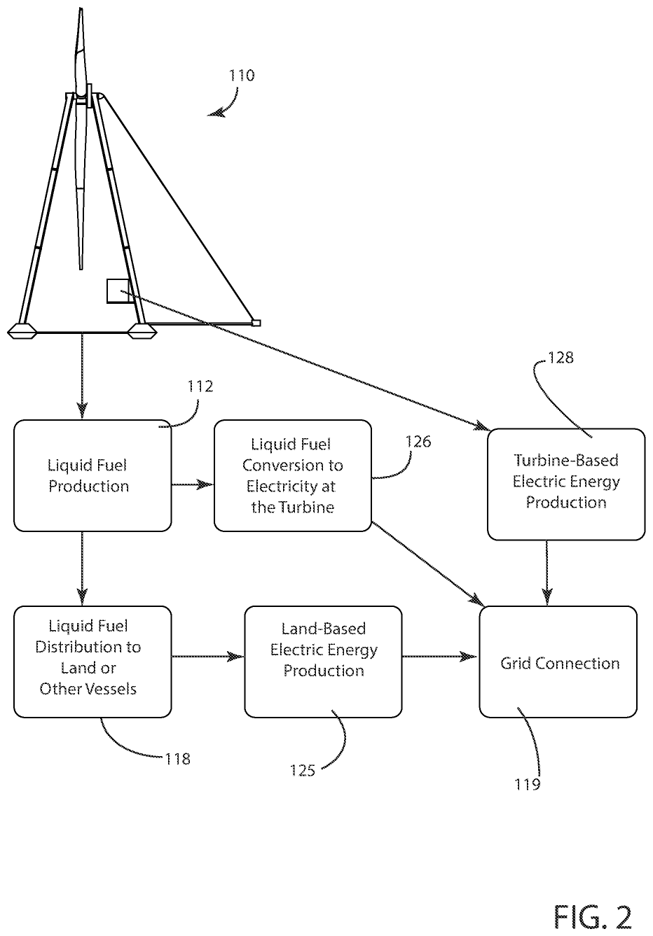

FIG. 2 is a diagram depicting the flow of fuel and energy in the systems depicted in FIG. 1. A wind turbine 110 generates electricity 128 that is then sent directly to a grid connection 119. In other situations, for example when the grid does not require additional power from the turbine, the turbine 110 generates electricity for fuel production 112. Liquid fuel 112, may be stored in containers on a barge 126 (FIG. 1). Stored liquid fuel may alternatively be used to produce electricity in an electrolyzer 126 based on the turbine 110 or may be transferred to other vessels or to land 118 where it may be used to produce electrical energy in an electrolyzer on land 125 where it may be transferred to a grid connection 119.

The example embodiments described herein should not be construed as limiting.

1. A method for producing electricity using a virtual ammonia battery, the method comprising:
generating electricity with an offshore fluid turbine; and
producing ammonia using said electricity; and
storing said ammonia; and
using said ammonia to power a generator; and
producing electricity.

2. The method for producing electricity using a virtual ammonia battery of claim 1 further comprising:
distributing said stored ammonia to a land based electrical generator apparatus.

3. The method for producing electricity using a virtual ammonia battery of claim 1 further comprising:
following said storing said ammonia;
distributing said ammonia to a sea faring vessel.

4. The method for producing electricity using a virtual ammonia battery of claim 1 further comprising:
distributing said ammonia to land-based electric energy production apparatus; and
producing electric energy; and
distributing said electric energy to an energy grid.

5. The method for producing electricity using a virtual ammonia battery of claim 1 further comprising:
generating electricity by way of an electrolyzer on said wind turbine; and
distributing said electricity to an energy grid.

6. A method for producing electricity using a virtual ammonia battery, the method comprising:
generating electricity with an offshore fluid turbine supporting a rotor with a lattice structure supported by shallow draft floats; and
distributing at least a first portion of said electricity to a land-based energy grid; and
powering an electrolyzer with at least a second portion of said electricity; and
producing ammonia using said at least a second portion of said electricity and said electrolyzer; and
storing said ammonia.

7. The for producing electricity using a virtual ammonia battery of claim 6, further comprising:
generating electricity by way of a generator and said ammonia; and
distributing said electricity to a land-based energy grid.
